(19) United States
(12) Patent Application Publication
(10) Pub. No.: US 2026/0219066 A1
(43) Pub. Date: Jul. 30, 2026

(54) GENERATION OF A ROUTE TO DOCK A MOBILITY AID ON A TARGET PLATFORM

(71) Applicant: Microchip Technology Incorporated, Chandler, AZ (US)

(72) Inventors: Iulia Olteanu, Bucharest (RO); Valentin Stoia, Bucharest (RO)

(73) Assignee: Microchip Technology Incorporated, Chandler, AZ (US)

(21) Appl. No.: 19/079,544

(22) Filed: Mar. 14, 2025

Related U.S. Application Data
(60) Provisional application No. 63/751,093, filed on Jan. 29, 2025.

(51) Int. Cl. G01C 21/00; G01C 21/20

(52) U.S. Cl. CPC G01C 21/3837; G01C 21/20

(57) ABSTRACT

A system and method for an automated interfacing system for docking a mobility aid with target platforms are disclosed. The method may include detecting, by a mobility aid equipped with a plurality of antennas, a presence of a target platform equipped with an antenna. The method may also include establishing a connection between the mobility aid and the target platform. The method may further include determining a relative position and an orientation between the mobility aid and the target platform. The method may be to generating a docking route to the target platform based on the determined relative position and orientation.

### PRIORITY

This application claims priority to U.S. Provisional Patent Application No. 63/751,093 filed January 29, 2025, the contents of which are hereby incorporated in their entirety.

### TECHNICAL FIELD

The present disclosure relates to accessibility systems, and more particularly to an automated interfacing system for docking a mobility aid with target platforms.

### BACKGROUND

Wheelchairs have long been used as mobility aids for individuals with limited or no ability to walk. As technology has advanced, electric wheelchairs have become increasingly sophisticated, offering improved control and independence for users. However, interfacing between wheelchairs and various platforms or vehicles remains a challenge in many situations. The process of aligning and docking a wheelchair with platforms such as public transportation vehicles, elevators, or specialized lifts can be difficult and time-consuming. Users often struggle with precise positioning, especially in crowded or time-constrained environments. This can lead to frustration, delays, and potential safety risks for wheelchair users and those around them.

### SUMMARY OF THE INVENTION

Aspects provide systems and methods for an automated interfacing system for docking a mobility aid with target platforms. Examples of the present disclosure may include an apparatus. The apparatus may include an interface to a plurality of antennas. The apparatus may also include a control circuit. The control circuit may be to establish a connection between a mobility aid and a target platform. The control circuit may also be to determine a relative position and an orientation between the mobility aid and the target platform. The control circuit may further be to generate a docking route to the target platform based on the determined relative position and orientation.

In combination with any of the above examples, the apparatus may include an interface to a proximity sensor. The control circuit may be to create a digital map of an area proximate to the mobility aid using information from the proximity sensor. The control circuit may also be to use the digital map when generating the docking route to the target platform.

In combination with any of the above examples, the control circuit may be to detect an obstacle. The control circuit may also be to adjust the docking route in response to the detection.

In combination with any of the above examples, the apparatus may include a user input interface coupled to the control circuit. The control circuit may be to receive a user command through the user input interface to initiate interfacing with the target platform.

In combination with any of the above examples, establishing the connection between the mobility aid and the target platform may include authenticating the mobility aid with the target platform by exchanging encrypted identification data.

In combination with any of the above examples, the control circuit may be to connect with an online monitoring software.

In combination with any of the above examples, the control circuit may be to notify the target platform when docking is complete.

Alone or in combination with any of the above examples, examples of the present disclosure may include a method. The method may include detecting, by a mobility aid equipped with a plurality of antennas, a presence of a target platform equipped with an antenna. The method may also include establishing a connection between the mobility aid and the target platform. The method may further include determining a relative position and an orientation between the mobility aid and the target platform. The method may be to generating a docking route to the target platform based on the determined relative position and orientation.

In combination with any of the above examples, the method may include receiving a user input to initiate automated interfacing with the target platform.

In combination with any of the above examples, the user input may include at least one of: a voice command system, a button, a brainwave input device, a breath-controlled input device, or an eye-tracking system.

In combination with any of the above examples, the method may include creating a digital map of an area proximate to the mobility aid using information from a proximity sensor. The method may also include using the digital map when generating the docking route to the target platform.

In combination with any of the above examples, the method may include detecting an obstacle. The method may include adjusting the docking route in response to the detection.

In combination with any of the above examples, establishing the connection between the mobility aid and the target platform may include authenticating the mobility aid with the target platform by exchanging encrypted identification data.

In combination with any of the above examples, the method may include notifying the target platform when docking is complete.

Alone or in combination with any of the above examples, examples of the present disclosure may include a system. The system may include a target platform including an antenna. The system may also include a mobility aid. The mobility aid may include a plurality of antennas and a control circuit. The control circuit may be to establish a connection between the mobility aid and the target platform. The control circuit may also be to determine a relative position and an orientation between the mobility aid and the target platform. The control circuit may further be to generate a docking route to the target platform based on the determined relative position and orientation.

In combination with any of the above examples, the mobility aid may include a proximity sensor. The control circuit may be to create a digital map of an area proximate to the mobility aid using information from the proximity sensor. The control circuit may also be to use the digital map when generating the docking route to the target platform.

In combination with any of the above examples, the control circuit may be to detect an obstacle. The control circuit may also be to adjust the docking route in response to the detection.

In combination with any of the above examples, the mobility aid may include a user input interface to receive a user command to initiate docking with the target platform.

In combination with any of the above examples, the mobility aid may include a communication circuit to connect with an online monitoring software.

In combination with any of the above examples, the control circuit may be to notify the target platform when docking is complete.

### BRIEF DESCRIPTION OF THE DRAWINGS

The figures illustrate examples of systems and methods for an automated interfacing system for docking a mobility aid with target platforms.

FIG. 1 illustrates a block diagram of a wheelchair system for use in an automated wheelchair interfacing system, according to examples of the present disclosure;

FIG. 2 illustrates a block diagram of a target platform system for use in an automated wheelchair interfacing system, according to examples of the present disclosure;

FIG. 3 illustrates a wheelchair navigation and docking system showing the interaction between a wheelchair system and a target platform system, according to examples of the present disclosure;

FIG. 4 illustrates a block diagram of a control circuit for a wheelchair system for use in an automated wheelchair interfacing system, according to examples of the present disclosure;

FIG. 5 illustrates a method for interfacing a wheelchair with a target platform, according to examples of the present disclosure; and

FIG. 6 illustrates a method for interfacing a mobility aid with a target platform, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, an automated interfacing system for docking a mobility aid with target platforms is provided. The automated wheelchair interfacing system may use Ultra-Wideband (UWB) technology to facilitate precise positioning and communication between a wheelchair and various target platforms. This system may enhance accessibility and safety for wheelchair users when interacting with different environments and transportation modes. The automated wheelchair interfacing system may be designed to accommodate various types of wheelchairs and target platforms, offering flexibility and adaptability across different scenarios and environments. The system may improve the independence and mobility of wheelchair users by streamlining the process of interacting with different platforms and transportation systems.

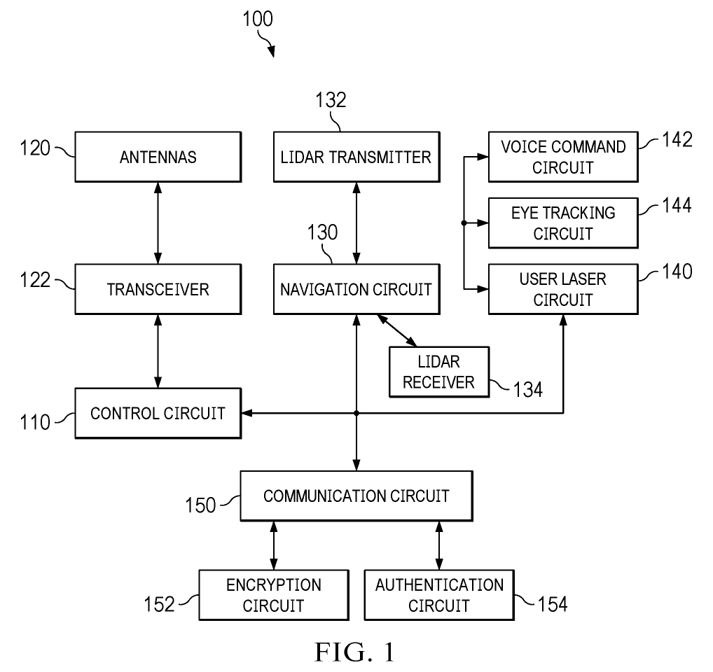

FIG. 1 illustrates a block diagram of a wheelchair system for use in an automated wheelchair interfacing system, according to examples of the present disclosure. Wheelchair system 100 may include control circuit 110, antennas 120, transceiver 122, navigation circuit 130, Light Detection and Ranging (LiDAR) transmitter 132, LiDAR receiver 134, user input circuit 140, voice command circuit 142, eye tracking circuit 144, communication circuit 150, encryption circuit 152, and authentication circuit 154. In some cases, wheelchair system 100 may include a frame (not shown in FIG. 1) that serves as the structural foundation for mounting the components of wheelchair system 100. The frame may be constructed from materials such as aluminum, steel, or carbon fiber to provide strength and durability while maintaining a lightweight structure.

Control circuit 110 may serve as the central control for wheelchair system 100, coordinating the functions of various components and executing instructions for navigation and interfacing tasks. In some examples, control circuit 110 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuit 110 may be implemented by instructions for execution by a processor through, for example, a function, application programming interface (API) call, script, program, compiled code, interpreted code, binary, executable, executable file, firmware, object file, container, assembly code, or object. For example, control circuit 110 may be implemented by instructions stored in a non-transitory medium such as a memory that, when loaded and executed by a processor such as a central processing unit (CPU) (or any other suitable process), cause the functionality of control circuit 110 described herein.

Control circuit 110 may be communicatively coupled to antennas 120 via transceiver 122. In some examples, antennas 120 may include three or more antennas mounted to the frame of wheelchair system 100, which may enable precise positioning and orientation determination. Antennas 120 may be strategically positioned to provide optimal coverage for signal reception and transmission. For example, antennas 120 may be placed at different corners or sides of the wheelchair frame to enable accurate triangulation of signals. Antennas 120 may enable accurate determination of the position and orientation of wheelchair system 100 relative to a target platform. The target platform, which may be various structures such as elevators, buses, driverless taxis, public transportation, boats, or specialized docking stations, may be equipped with at least one antenna.

Transceiver 122 may be coupled to antennas 120. Transceiver 122 may be responsible for processing the signals received and transmitted by antennas 120. Transceiver 122 may facilitate accurate distance measurements and data exchange with the target platform and enable high-precision ranging and positioning capabilities for the navigation and interfacing functions of wheelchair system 100. Antennas 120 and transceiver 122 may use Ultra-Wideband (UWB) technology for its accuracy in positioning, for example, UWB transmits through people in crowded areas and may have an accuracy within a few centimeters. However, alternative wireless protocols may be employed in certain scenarios. For instance, Bluetooth Low Energy (BLE) may be used in environments where UWB signals face interference or where lower power consumption is prioritized. Similarly, Wi-Fi may be used for longer-range communication between the wheelchair and target platforms, particularly in large indoor spaces. In some examples, any alternate radiofrequency (RF) interface with accurate time-of-flight determination may be used.

Wheelchair system 100 may include navigation circuit 130. Navigation circuit 130 may be communicatively coupled to LiDAR transmitter 132 and LiDAR receiver 134. LiDAR transmitter 132 and LiDAR receiver 134 may be used for environmental sensing and mapping. LiDAR transmitter 132 may emit laser pulses and LiDAR receiver 134 may measure the reflections of the laser pulses to create 3D digital maps of the area proximate to wheelchair system 100, which may be used for obstacle detection and navigation planning. Navigation circuit 130 may process the data from LiDAR receiver 134 to identify potential obstacles in the path of wheelchair system 100. In some cases, navigation circuit 130 may generate a docking route to the target platform based on the determined relative position and orientation. Navigation circuit 130 may also dynamically adjust the docking route in response to detecting stationary obstacles, moving obstacles (or both), enhancing the ability of wheelchair system 100 to navigate complex environments safely. While a LiDAR system is described, other types of proximity sensors may be used, such as ultrasound.

User input circuit 140 may be communicatively coupled to control circuit 110. User input circuit 140 may allow the user of wheelchair system 100 to interact with wheelchair system 100, providing commands or selecting options. User input circuit 140 may take various forms, such as buttons (mechanical and capacitive), touchscreens, voice recognition systems, or even brain-computer interfaces (e.g., electroencephalogram (EEG) analysis), depending on the specific needs and capabilities of the user. For example, user input circuit 140 may be communicatively coupled to voice command circuit 142 and eye tracking circuit 144. Voice command circuit 142 may enable voice command inputs, allowing users to control wheelchair system 100 through spoken instructions. Eye tracking circuit 144 may provide an alternative input method, allowing control of wheelchair system 100 through eye movements. In some cases, user input circuit 140 may include other input methods such as a brain-computer interface or a breath-controlled input device. For example, a sip-and-puff control system may be implemented as part of user input circuit 140, providing an additional option for users with limited mobility.

Communication circuit 150 may be communicatively coupled to control circuit 110 and encryption circuit 152 and authentication circuit 154. Encryption circuit 152 may secure data transmission between wheelchair system 100 and a target platform, protecting sensitive information during the interfacing process. Authentication circuit 154 may verify communications between wheelchair system 100 and a target platform by exchanging encrypted identification data to ensure that authorized interactions occur.

Control circuit 110, navigation circuit 130, user input circuit 140, and communication circuit 150 may work together to enable automated interfacing with the target platform. For example, control circuit 110 may provide location data based on information from transceiver 122, navigation circuit 130 may determine the wheelchair’s position relative to the target platform and generate a docking route, which may be dynamically adjusted based on obstacle detection. Control circuit 110. may continuously update the position of wheelchair system 100 using antennas 120 and transceiver 122. User input circuit 140 may allow the user to initiate the interfacing process or provide input during navigation. Throughout the process, communication circuit 150 may ensure secure and authenticated communication with the target platform.

The modular architecture of wheelchair system 100 may allow for flexibility in implementation and customization based on specific user needs and environmental requirements. By integrating navigation, user input, and communication capabilities, wheelchair system 100 may provide a comprehensive solution for automated interfacing with various target platforms.

While wheelchair system 100 is described as a wheelchair, wheelchair system 100 may be any suitable mobility aid that uses assistance to board a target platform system, including, but not limited to, motorized scooters, strollers, exoskeletons, or robotic legs.

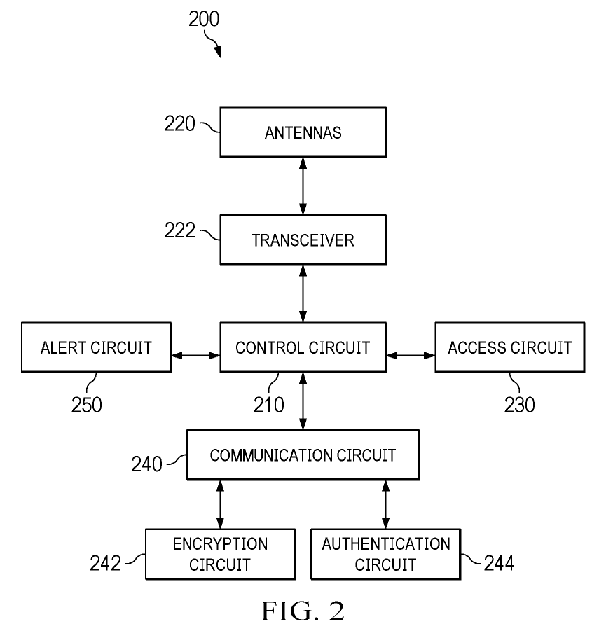

FIG. 2 illustrates a block diagram of a target platform system for use in an automated wheelchair interfacing system, according to examples of the present disclosure. Target platform system 200 may include control circuit 210, antenna 220, transceiver 222, access circuit 230, communication circuit 240, and alert circuit 250 that work together to facilitate wheelchair docking and interfacing.

Control circuit 210 may coordinate the functions of various components and execute instructions for managing the target platform's operations during wheelchair interfacing. In some examples, control circuit 210 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuit 210 may be implemented by instructions for execution by a processor through, for example, a function, application programming interface (API) call, script, program, compiled code, interpreted code, binary, executable, executable file, firmware, object file, container, assembly code, or object. For example, control circuit 210 may be implemented by instructions stored in a non-transitory medium such as a memory that, when loaded and executed by a processor such as a central processing unit (CPU) (or any other suitable process), cause the functionality of control circuit 210 described herein.

Antenna 220 may receive and transmit signals, enabling positioning and communication with approaching wheelchair systems. While one antenna 220 is shown in FIG. 2, target platform system 200 may include more than one antenna 220. In some examples, target platform system 200 may have additional antennas placed along its length for more precise localization. For example, in situations where target platform system 200 is large, target platform system 200 may include multiple antenna 220 (e.g., one antenna 220 to guide a wheelchair system up a ramp and through a door and a second antenna 220 to guide the wheelchair system to a designated area of target platform system 200 once the wheelchair system is onboard.

Transceiver 222 may be communicatively coupled to control circuit 210 and to antenna 220. Transceiver 222 may process the signals received and transmitted by antenna 220, enabling accurate distance measurements and data exchange with wheelchair systems. Antennas 220 and transceiver 222 may use Ultra-Wideband (UWB) technology for its accuracy in positioning, for example, UWB transmits through people in crowded areas and may have an accuracy within a few centimeters. However, alternative wireless protocols may be employed in certain scenarios. For instance, Bluetooth Low Energy (BLE) may be used in environments where UWB signals face interference or where lower power consumption is prioritized. Similarly, Wi-Fi may be used for longer-range communication between the wheelchair and target platforms, particularly in large indoor spaces.

Access circuit 230 may manage and control various access mechanisms (e.g., ramp, lift, door) cause an access mechanism to be made available to the approaching wheelchair system in response to establishing a connection with the approaching wheelchair system. For example, access circuit 230 may deploy a ramp or lift to facilitate wheelchair boarding when a connection is established with an approaching wheelchair system. In other examples, access circuit 230 may activate an automated door opening system.

Communication circuit 240 may enable data exchange between target platform system 200 and the approaching wheelchair system. This may include transmitting platform status information, receiving wheelchair positioning data, or exchanging authentication credentials. In some examples, communication circuit 240 may include encryption circuit 242 and authentication circuit 244. Encryption circuit 242 may secure data transmission between target platform system 200 and the wheelchair system, protecting sensitive information during the interfacing process. Authentication circuit 244 may verify communications between target platform system 200 and the wheelchair system by exchanging encrypted identification data, ensuring that authorized interactions occur.

Target platform system 200 may facilitate the safe and efficient docking of the wheelchair system on target platform system 200. For example, when a wheelchair system approaches, antenna 220 and transceiver 222 may detect its presence and determine its relative position. Presence detection may be used in crowded areas where an operator of target platform system 200 may not be aware of the wheelchair system’s presence. Control circuit 210 may use this information to coordinate the deployment of an access point (via access circuit 230) and manage the communication process through communication circuit 240.

In some examples, control circuit 210 may be responsible for ensuring safe operations during the wheelchair docking process by monitoring the deployment of access mechanisms, detect potential hazards, and providing alerts or initiating safety protocols.

Alert circuit 250 may provide visual, auditory, or tactile feedback to both the wheelchair user and the platform operator. In some examples, alert circuit 250 may indicate the status of the docking process, alert users to potential issues, or provide guidance for successful interfacing.

Control circuit 210, antenna 220, transceiver 222, access circuit 230, communication circuit 240, and alert circuit 250 may work together to facilitate safe and efficient wheelchair docking. For example, when a wheelchair system approaches, control circuit 210 may detect its presence and determine its relative position using information from antenna 220 and transceiver 222. Control circuit 210 may use this information to coordinate the deployment of appropriate access mechanisms through access circuit 230. Throughout the process, control circuit 210 may ensure safe operations, while communication circuit 240 may manage secure data exchange with the wheelchair system. Alert circuit 250 may provide real-time feedback to both the wheelchair user and platform operator, enhancing the overall safety and efficiency of the docking process.

Target platform system 200 may be adaptable to various types of platforms, such as buses, trains, elevators, or specialized docking stations. The specific configuration of components may vary depending on the platform type and intended use case, providing flexibility in implementation across different scenarios. The modular architecture of target platform system 200 may allow for flexibility in implementation and customization based on specific platform types and environmental requirements. By integrating advanced positioning, access control, safety monitoring, and communication capabilities, target platform system 200 may provide a comprehensive solution for automated interfacing with various wheelchair systems.

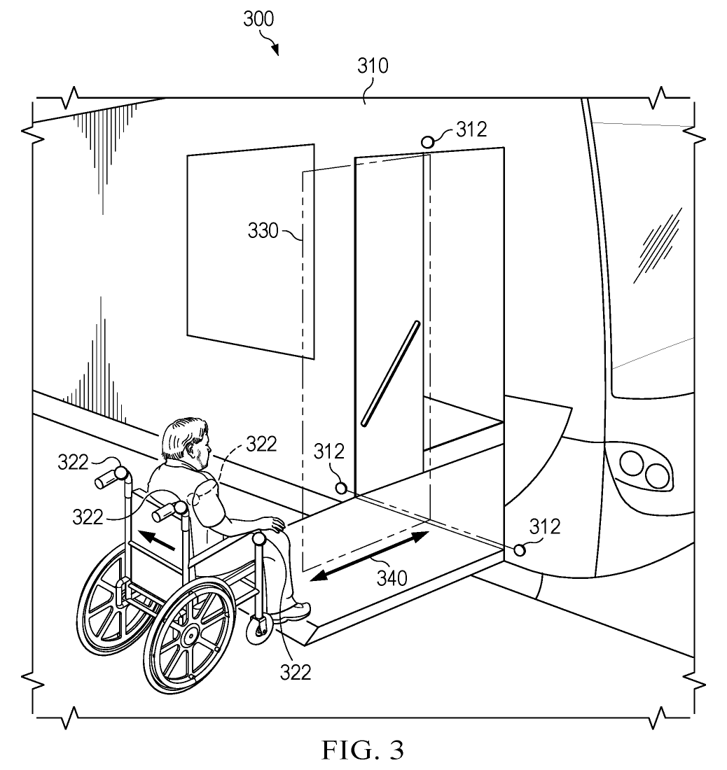

FIG. 3 illustrates a wheelchair navigation and docking system showing the interaction between a wheelchair system and a target platform system, according to examples of the present disclosure. System 300 may incorporate multiple technologies for positioning and guidance. Target platform system 310 may be similar to target platform system 200 shown in FIG. 2. Wheelchair system 320 may be similar to wheelchair system 100 shown in FIG. 3.

In some examples, virtual approach plane 330 may extend perpendicular from the entrance area of target platform system 310, providing a reference for alignment. Virtual approach plane 330 may serve as a guideline for wheelchair system 320 to approach target platform system 310 in a controlled manner.

Wheelchair system 320 may utilize antennas 322 positioned at strategic points on both the wheelchair system 320 and target platform system 310. Antennas 322 may enable positioning and communication between wheelchair system 320 and target platform system 310. The transceivers connected to these antennas may process the signals, allowing for distance measurements and data exchange. Antennas 322 may be similar to antennas 120 shown in FIG. 1.

Calculated movement path 340 may be generated, showing the intended trajectory for wheelchair system 320 to approach the entrance of target platform system 310. Calculated movement path 340 may be dynamically updated based on real-time positioning data from antennas 322 and environmental information from other sensors.

Wheelchair system 320 may incorporate a LiDAR dynamic mapping and navigation 360-degree system for scanning and navigating the surrounding environment. The LiDAR dynamic mapping and navigation 360-degree system may allow wheelchair system 320 to detect obstacles in an area proximate to wheelchair system 320 and adjust calculated movement path 340 while wheelchair system 320 moves toward the entrance of target platform system 310. While the mapping is described as being created using a LiDAR system, other types of proximity sensors may be used, such as ultrasound.

In some examples, wheelchair system 320 may have four or more antennas 322 placed at each corner of its frame which may enhance the accuracy of positioning and orientation determination, particularly in complex environments with potential signal interference.

Wheelchair system 320 system may incorporate a camera-based computer vision system in addition to or as an alternative to the LiDAR system. The camera-based system may use image recognition algorithms to identify visual cues in the environment, such as signage or specific features of target platform system 310. The data from this system may be integrated with information from the antenna-based positioning and LiDAR systems to enhance navigation accuracy.

The various positioning and navigation technologies in system 300 may work together to guide wheelchair system 320 along calculated movement path 340 to interface with the entrance of target platform system 310. Virtual approach plane 330 and calculated movement path 340 may provide reference guidelines for the navigation system of wheelchair system 320 to follow while maintaining proper alignment with the entrance of target platform system 310.

The transceivers, LiDAR dynamic mapping and navigation 360-degree system, the camera-based computer vision system, or any combination thereof may work in conjunction to enable precise positioning and obstacle avoidance during the docking procedure. This multi-layered approach to positioning and guidance may facilitate safe and accurate docking of wheelchair system 320 with target platform system 310 across various environmental conditions.

System 300 may integrate various components and methods to provide a comprehensive solution for enhancing mobility and accessibility. For example, system 300 may incorporate a cloud-based platform that connects multiple wheelchair systems 320 and target platform systems 310. This cloud-based integration may enable features such as real-time tracking of available accessible transportation, predictive maintenance for wheelchairs based on usage data, and crowdsourced accessibility information for various locations. Additionally, cloud-based integration may provide a connection to online monitoring software for remote operation and enable online and safety monitoring. Further, cloud-based integration may allow for ticketing functionality to be incorporated into the automated wheelchair interfacing system. In some examples, wheelchair system 320 may include a real-time clock calendar (RTCC) chip to perform event logging.

System 300 may be adaptable for use in emergency services and evacuation scenarios. In such cases, the positioning technology may guide users of wheelchair system 320 to the nearest accessible exit or safe zone during emergencies. System 300 may interface with emergency response vehicles or evacuation equipment, potentially improving safety and emergency preparedness for individuals with mobility limitations in various public and private settings.

In some examples, system 300 may be applied to warehouse and logistics operations. System 300 may allow users of wheelchair system 320 to interact with target platform systems 310 such as elevated platforms, conveyor belts, and automated guided vehicles in warehouse environments. This application may improve workplace accessibility and productivity in distribution centers and fulfillment facilities.

System 300 may also be used in airports to enhance accessibility during air travel. Users of wheelchair system 320 may automatically interface with check-in kiosks, security screening equipment, boarding bridges, and specialized lifts for entering aircraft. System 300 may guide users through complex airport layouts and facilitate smooth transitions between different areas and equipment.

System 300 may be integrated into smart home ecosystems. Positioning beacons may be installed throughout a home, allowing wheelchair system 320 to interface with various home automation systems. For example, wheelchair system 320 may automatically adjust its height to interface with kitchen counters, open doors, or control home entertainment systems.

The user input interface of wheelchair system 320 may be customized based on individual user needs and capabilities. In addition to voice commands and eye-tracking, the system may incorporate other input methods such as a breath-controlled input device (e.g., sip-and-puff control system), a brainwave input device (e.g., brain-computer interface), or specialized buttons (mechanical or capacitive) for users with limited mobility.

Implementation considerations for system 300 may include ensuring compatibility with existing accessibility standards and regulations for public transportation and buildings. System 300 may need to be designed with flexibility to accommodate various types of wheelchair systems 320 and target platform systems 310, offering adaptability across different scenarios and environments.

Security and privacy considerations may be considered in the implementation of the wheelchair interfacing system. Encryption and authentication protocols may be employed to protect sensitive user data and prevent unauthorized access to the system. In some cases, the system may incorporate multi-factor authentication methods to enhance security.

A manufacturer of wheelchair system 320 may collaborate with manufacturers of target platform system 310, service providers of target platform 310, and regulatory bodies. This collaboration may ensure seamless integration and compliance with relevant standards and regulations.

In some implementations, system 300 may incorporate machine learning algorithms to improve its performance over time. These algorithms may analyze data from multiple wheelchair-platform interactions to create routing, predict potential issues, and enhance the overall user experience. In some examples, system 300 may use machine learning algorithms to recognize and interpret visual cues in the environment, such as signage, obstacles, or the specific shape of target platforms.

System 300 may also include features for remote monitoring and assistance. In some cases, caregivers or support personnel may be able to remotely monitor the status of wheelchair system 320 and provide assistance if needed, enhancing the safety and independence of users.

By integrating these various components and methods, system 300 may provide a solution for enhancing mobility and accessibility across a wide range of environments and use cases. The adaptability of system 300 and potential for customization may allow it to address the diverse needs of wheelchair users in various settings, from everyday home use to complex public transportation scenarios.

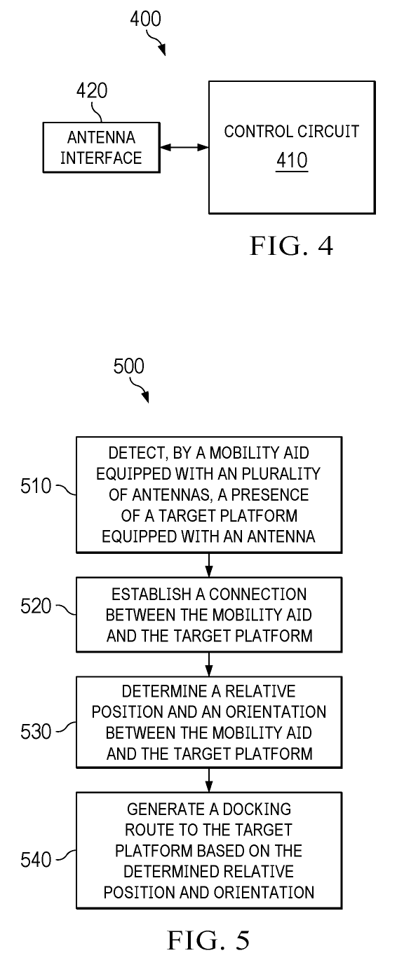

FIG. 4 illustrates a block diagram of a control circuit for a wheelchair system for use in an automated wheelchair interfacing system, according to examples of the present disclosure. System 400 may include control circuit 410 and antenna interface 420. Control circuit 410 may be similar to control circuit 110 shown in FIG. 1.

Control circuit 410 may be communicatively coupled to antennas and a transceiver via antenna interface 420. The antennas and transceiver may be similar to antennas 120 and transceiver 122 shown in FIG. 1.

Control circuit 410 may establish a connection between a wheelchair and the target platform. The connection may be established by receiving information via antenna interface 420. In some examples, control circuit 410 may perform an authentication with the target platform and encrypt the connection as described with respect to FIG. 1 (referring to communication circuit 150, encryption circuit 152, and authentication circuit 154).

Control circuit 410 may also determine a relative position and an orientation between the wheelchair and the target platform. The position and orientation may be based on information on the antennas (via antenna interface 420).

Control circuit 410 may further generate a docking route to the target platform based on the determined relative position and orientation. The docking route may also consider the environment surrounding the wheelchair. For example, control circuit 410 may use information from a LiDAR receiver, such as LiDAR receiver 134, to create a digital map of an area proximate to the wheelchair and identify and avoid obstacles in the path of the wheelchair. While the digital map is described as being created using a LiDAR system, other types of proximity sensors may be used, such as ultrasound.

Control circuit 410 may also be coupled to a user input interface and may receive a user command via the user input interface. The user command may instruct the control circuit to initiate interfacing with the target platform.

Once the wheelchair has docked with the target platform, control circuit 410 may notify the target platform that docking is complete. The notification may be used by an operator of the target platform to indicate when it is safe for the target platform to begin movement.

In some examples, control circuit 410 may connect with online monitoring software that provides real-time information regarding the location and status of the wheelchair.

FIG. 5 illustrates a method for interfacing a mobility aid with a target platform, according to examples of the present disclosure. Method 500 may be implemented by wheelchair system 100 or 320, shown in FIGS. 1 and 3, respectively, and target platform system 200 and 310, shown in FIGS. 2 and 3, respectively. Although examples have been described above, other variations and examples may be made from this disclosure without departing from the spirit and scope of these disclosed examples.

Method 500 may begin at block 510, where the presence of a target platform may be detected by a mobility aid equipped with a plurality of antennas. For example, control circuit 110 of the wheelchair system 100, shown in FIG. 1, may detect a presence of a target platform equipped with at least one antenna 220 shown in FIG. 2. The detection may be performed using antennas 120 of wheelchair system 100.

At block 520, a communication connection may be established between the mobility aid and the target platform. For example, communication circuit 150 of wheelchair system 100 may establish a connection with communication circuit 240 of target platform system 200 based on the determined relative position and orientation. The communication connection may enable the exchange of information and commands between the mobility aid and the target platform, facilitating a coordinated interfacing process. The communication connection may be encrypted. In some examples, the mobility aid and the target platform may authenticate one another by exchanging encrypted identification data to ensure secure and authorized communication during the interfacing process.

At block 530, the relative position and orientation between the mobility aid and the target platform may be determined. For example, control circuit 110 may determine a relative position and orientation between wheelchair system 100 and target platform system 200. This determination may involve processing signals received by the transceiver 122 from antennas 120 of the wheelchair system 100 and the antenna 220 of the target platform system 200. The control circuit may leverage the multiple antennas on the mobility aid and the target platform to accurately calculate their spatial relationship.

At block 540, a docking route to the target platform may be generated based on the determined relative position and orientation. For example, control circuit 110 may initiate an automated docking procedure to guide wheelchair system 100 to interface with target platform system 200. In some examples, this route generation may be performed by a LiDAR-based autonomous navigation system. The generated route may consider the relative position and orientation determined earlier, as well as any obstacles or environmental factors detected by the LiDAR system.

In some examples, before initiating the docking procedure, a user input may be checked. In some cases, user input circuit 140 of the wheelchair system 100 may receive a command from the user to initiate interfacing with the target platform system 200. This user input may be provided through any suitable means, such as a voice command system, a button, a brainwave input device, a breath-controlled input device, an eye-tracking system, or other specialized command circuit. This command may trigger the subsequent steps in the interfacing process. The user input may also allow for user control and confirmation before proceeding with the automated docking procedure. For example, the user may instruct the wheelchair system 100 to proceed with boarding a specific target platform system if multiple options are available.

The mobility aid may be guided to interface with the platform. In some examples, navigation circuit 130 may guide wheelchair system 100 along the generated docking route while monitoring for potential obstacles. A LiDAR dynamic mapping and navigation 360-degree system may provide real-time environmental data to assist in this process. Navigation circuit 130 may monitor the environment and adjust the route if obstacles (moving or stationary) are detected to help ensure safe navigation to the target platform. As the wheelchair follows the generated docking route, the system may continue to exchange data with the target platform. This ongoing communication may allow for real-time updates and coordination throughout the interfacing process.

Method 500 may provide a systematic approach for automated wheelchair interfacing, leveraging the advanced positioning, navigation, and communication capabilities of the wheelchair system 100 and the target platform system 200 to enhance mobility and accessibility for mobility aid users.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

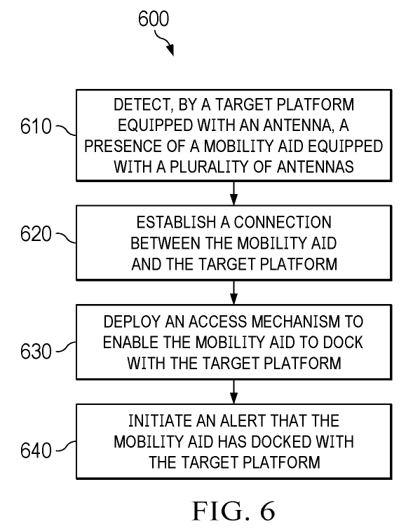

FIG. 6 illustrates a method for interfacing a mobility aid with a target platform, according to examples of the present disclosure. Method 600 may be implemented by target platform system 200 and 310, shown in FIGS. 2 and 3 and wheelchair system 100 or 320, shown in FIGS. 1 and 3, respectively. Although examples have been described above, other variations and examples may be made from this disclosure without departing from the spirit and scope of these disclosed examples.

Method 600 may begin at block 610, where the presence of a mobility aid may be detected by a target platform equipped with an antenna. For example, control circuit 210 of target platform system 200, shown in FIG. 2, may detect a presence of a mobility aid equipped with a plurality of antennas. The detection may be performed using antennas 220 of target platform system 200.

At block 620, a communication connection may be established between the mobility aid and the target platform. For example, communication circuit 240 of target platform system 200 may establish a connection with communication circuit 150 of wheelchair system 100 based on the determined relative position and orientation. The communication connection may enable the exchange of information and commands between the mobility aid and the target platform, facilitating a coordinated interfacing process. The communication connection may be encrypted. In some examples, the mobility aid and the target platform may authenticate one another to ensure secure and authorized communication during the interfacing process.

At block 630, an access mechanism (e.g., ramp, lift, door) may be deployed to enable to the mobility aid to dock with the target platform. For example, the access mechanism may be deployed in response to establishing a connection with an approaching mobility aid (at block 620). For example, a ramp or lift may be deployed to facilitate boarding when a connection is established with an approaching mobility aid. In other examples, an automated door opening system may be activated.

At block 640, an alert may be initiated to indicate that the mobility aid has docked with the target platform. The alert may provide visual, auditory, or tactile feedback to both the mobility aid user and the platform operator. In some examples, the alert may indicate the status of the docking process, alert users to potential issues, or provide guidance for successful interfacing.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. An apparatus, comprising:
an interface to a plurality of antennas; and
a control circuit to:
establish a connection between a mobility aid and a target platform;
determine a relative position and an orientation between the mobility aid and the target platform; and
generate a docking route to the target platform based on the determined relative position and orientation.

2. The apparatus of claim 1, comprising an interface to a proximity sensor; and wherein the control circuit is to:
create a digital map of an area proximate to the mobility aid using information from the proximity sensor; and
use the digital map when generating the docking route to the target platform.

3. The apparatus of claim 2, wherein the control circuit is to:
detect an obstacle; and
adjust the docking route in response to the detection.

4. The apparatus of claim 1, comprising a user input interface coupled to the control circuit, the control circuit is to receive a user command through the user input interface to initiate interfacing with the target platform.

5. The apparatus of claim 1, wherein establishing the connection between the mobility aid and the target platform includes authenticating the mobility aid with the target platform by exchanging encrypted identification data.

6. The apparatus of claim 1, wherein the control circuit is to connect with an online monitoring software.

7. The apparatus of claim 1, wherein the control circuit is to notify the target platform when docking is complete.

8. A method, comprising:
detecting, by a mobility aid equipped with a plurality of antennas, a presence of a target platform equipped with an antenna;
establishing a connection between the mobility aid and the target platform;
determining a relative position and an orientation between the mobility aid and the target platform; and
generating a docking route to the target platform based on the determined relative position and orientation.

9. The method of claim 8, comprising receiving a user input to initiate automated interfacing with the target platform.

10. The method of claim 9, wherein the user input includes at least one of: a voice command system, a button, a brainwave input device, a breath-controlled input device, or an eye-tracking system.

11. The method of claim 8, comprising:
creating a digital map of an area proximate to the mobility aid using information from a proximity sensor; and
using the digital map when generating the docking route to the target platform.

12. The method of claim 11, comprising:
detecting an obstacle; and
adjusting the docking route in response to the detection.

13. The method of claim 8, wherein establishing the connection between the mobility aid and the target platform includes authenticating the mobility aid with the target platform by exchanging encrypted identification data.

14. The method of claim 8, comprising notifying the target platform when docking is complete.

15. A system, comprising:
a target platform including an antenna; and
a mobility aid including:
a plurality of antennas; and
a control circuit to:
establish a connection between the mobility aid and the target platform;
determine a relative position and an orientation between the mobility aid and the target platform; and
generate a docking route to the target platform based on the determined relative position and orientation.

16. The system of claim 15, wherein:
the mobility aid includes a proximity sensor; and
the control circuit is to:
create a digital map of an area proximate to the mobility aid using information from the proximity sensor; and
use the digital map when generating the docking route to the target platform.

17. The system of claim 16, wherein the control circuit is to:
detect an obstacle; and
adjust the docking route in response to the detection.

18. The system of claim 15, wherein the mobility aid includes a user input interface to receive a user command to initiate docking with the target platform.

19. The system of claim 15, wherein the mobility aid includes a communication circuit to connect with an online monitoring software.

20. The system of claim 15, wherein the control circuit is to notify the target platform when docking is complete.
